(19) United States
(12) Patent Application Publication
(10) Pub. No.: US 2022/0234323 A1
(43) Pub. Date: Jul. 28, 2022

(54) ULTRASONICALLY JOINED HANG TAB

(71) Applicant: MYS Global Inc., Sunnyvale, CA (US)

(72) Inventors: Hu Shi, Guangdong (CN); Sun Ying, Guangdong (CN)

(21) Appl. No.: 17/585,579

(22) Filed: Jan. 27, 2022

Related U.S. Application Data
(60) Provisional application No. 63/141,986, filed on Jan. 27, 2021.

(51) Int. Cl. B31D 1/00

(52) U.S. Cl. CPC B31D 1/0075

(57) ABSTRACT

A system and method for joining a plurality of paper material together with ultrasonic welding to form a hang tab for displaying products, such as, e.g., in a retail environment, without the use of an adhesive, such as, e.g., glue, and/or printing dye or ink. The paper hang tab may replace plastic hooks or tabs, which may be more environmentally beneficial. Two or more pieces of paper may be inserted into a gap between a sonotrode and an anvil of an ultrasonic joining device. A joining force from an actuator may be applied to secure the pieces of paper, and the sonotrode may oscillate a high-frequency. Adequate compaction of the pieces of paper is produced in addition to a high development of heat from friction generated in the micro-region of the thermoplastic coating. Melting of thermoplastic coating then forms a physical connection between the pieces of paper, effectively fusing them together.

### CLAIMS OF PRIORITY

This patent application claims priority from:

(1) U.S. provisional patent application No. 63/141,986, entitled ‘Ultrasonically joined hang tab’ filed on Jan. 27, 2021.

The application is incorporated by reference herein in its entirety.

### FIELD OF TECHNOLOGY

This disclosure relates to ultrasonically joining paper material to manufacture a hang tab for displaying a product.

### BACKGROUND

A hang tab may be a tag attached to a packaging of an article of merchandise for display in a retail environment, or for giving information about its material and proper care. In the packaging industry, numerous types of adhesive bonding connections for the manufacturing of hang tabs may be used with the aid of adhesive emulsions, such as, e.g., cold glue, and hot-melt adhesives, such as, e.g., hot glue.

Ultrasonic welding is an industrial manufacturing process whereby high frequency acoustic vibrations are applied to mating work pieces held together under pressure to create a solid-state bond. Ultrasonic welding may be preferable to other bonding methods in high volume manufacturing environments due to short weld times and ease of automation. An ultrasonic welding apparatus may include a welding tip—a sonotrode—that applies mechanical vibrations above an audible range to a surface of one of the parts to be bonded. These vibrations may be directed into two mating parts that are held together under pressure, and the resulting friction may cause any material along the mating surfaces of the pieces to fuse, creating a weld. This local material transformation is a result of the work pieces absorbing the frequency and amplitude of the vibration energy that is applied. The sonotrode can limit initial contact between the mating parts to a very small area, and thus focus the ultrasonic energy at the apex of its triangular or wedge-like shape, which includes a tapered end. Normally, an upper piece is pressed straight down into a lower piece during the welding operation to ensure that approximately equal amounts of ultrasonic energy are applied along the surface of the sonotrode. Depending on the work pieces that need to be joined, it is often desirable to connect flexible materials without actually stitching the materials together as this would create holes in the materials, such as, e.g., through which liquid could penetrate. For example, flexible thermoplastic materials would benefit from being joined together without stitching.

As compared with the adhesive bonding process, ultrasonic welding requires less time and energy, since no continuous heating of glue is necessary. The energy used for the ultrasonic joining process is needed only in the period of the joining time, which may be in the millisecond range. In addition, there is no risk of migration of glue, which may provide for a cleaner and more hygienic work product. The ultrasonic process may be suitable for mass production in high numbers.

### SUMMARY

A system and method for ultrasonically welding a paper blank to form a hang tab coats the blank with a thermoplastic material, kiss-cuts the blank to form one or more fold lines, folds the blank inward along the one or more fold lines toward a middle line, bonds one or more folds corresponding to the fold lines to a middle portion of the blank using an ultrasonic welding apparatus, and die-cuts one or more shapes of a hang tab. The bonding the one or more folds comprises positioning a joining site of the one or more folds and the middle portion within a gap between a sonotrode and an anvil of the ultrasonic welding apparatus, applying a joining force to the joining site, and oscillating the sonotrode at an ultrasonic frequency. The oscillation of the sonotrode is parallel or perpendicular to the joining force. For example, a fold may be half the width of the middle portion of the paper blank, depending on a predetermined final shape and size of the hang tab. In some cases the blank is not coated with thermoplastic material, and in other cases it is moistened with demineralized water.

The hang tab may include a bottom portion that is substantially square shape configured to adhere to a packaging of a retail item, and a top portion may include a substantially square shape middle portion disposed between two substantially square shape tabs. The middle portion may be larger than the two substantially square shape tabs, and includes a substantially triangular opening. The substantially triangular opening may include two rounded acute corners and a sharp obtuse corner configured to mount to a display apparatus of a retail environment. The top portion and the bottom portion of the hang tab are divided by the middle line. The middle line may be a physical depression formed from the folds. The system and method is not so limited, and other configurations for the hang tab are possible.

### BRIEF DESCRIPTION OF THE DRAWINGS

Figures are illustrated by way of example and are not limited to the accompanying drawings, in which, like references indicate similar elements.

FIG. 1 is a schematic diagram of an ultrasonic welding assembly.

FIG. 2 is a schematic diagram of a portion of an ultrasonic welding assembly.

FIG. 3 is a block diagram of an electronic controller of an ultrasonic welding assembly.

FIGS. 4A-E schematically outline a method for manufacturing a hang tab using an ultrasonic welding apparatus.

FIG. 5 is a flowchart of a method for joining a plurality of paper material using an ultrasonic welding apparatus.

FIG. 6 is a flowchart of a method for manufacturing a hang tab using an ultrasonic welding apparatus.

FIGS. 7A-D illustrate a variety of hang tab shapes that may be manufactured using an ultrasonic welding apparatus.

### DETAILED DESCRIPTION

Although the present has been described with reference to specific examples, it will be evident that various modifications and changes may be made without departing from their spirit and scope. The modifications and variations include any relevant combination of the disclosed features. Equivalent elements, materials, processes or steps may be substituted for those representatively illustrated and described herein. Certain structures and features may be utilized independently of the use of other structures and features. In addition, the components shown in the figures, their connections, couplings, relationships, and their functions, are meant to be exemplary only, and are not meant to limit the examples described herein.

A plurality of paper material joined together with ultrasonic welding to form a hang tab for displaying products, such as, e.g., in a retail environment, without the use of an adhesive, such as, e.g., glue, and/or printing dye or ink. The paper hang tab may replace plastic hooks or tabs, which may be more environmentally beneficial. The paper material, such as, e.g., cardboard, paperboard, Couche paper, tissue paper, newsprint paper, repro paper, recycled paper, construction paper, or cardstock, may be thermoplastically coated, such as, e.g., with polyethylene or polypropylene. The paper material may be corrugated or non-corrugated. Two or more pieces of paper may be inserted into a gap between a sonotrode and an anvil of an ultrasonic joining device. A joining force from an actuator, such as, e.g., pneumatic, mechanical, piezoelectric or hydraulic, may be applied to secure the pieces of paper, and the sonotrode may oscillate a high-frequency vibration, either parallel or perpendicular, to the joining force. Adequate compaction of the pieces of paper is produced in addition to a high development of heat from friction generated in the micro-region of the thermoplastic coating. Melting of the coating then forms a physical connection between the pieces of paper, effectively fusing them together. A transducer of the device may be configured to impart the vibration to a welding tip of the sonotrode in response to an electrical signal received from an electronic controller.

In some cases, the paper material is not thermoplastically coated, and the heat energy that is generated from molecular friction permits direct joining of the pieces of paper. In other cases, ultrasonic welding of pieces of paper takes place with the inner joining points being moistened, e.g., with liquid water, water vapor, and/or a humectant. This facilitates a firm and stable joining of the paper material without adhesives, thermoplastic coatings, and printing ink or dyes. Demineralized water may be used, opposed to conventional water, which may have reduced surface tension of the moistening agent. This may lead to a more uniformly wetted area, and the ability to penetrate paper more quickly with a relatively high tensile strength.

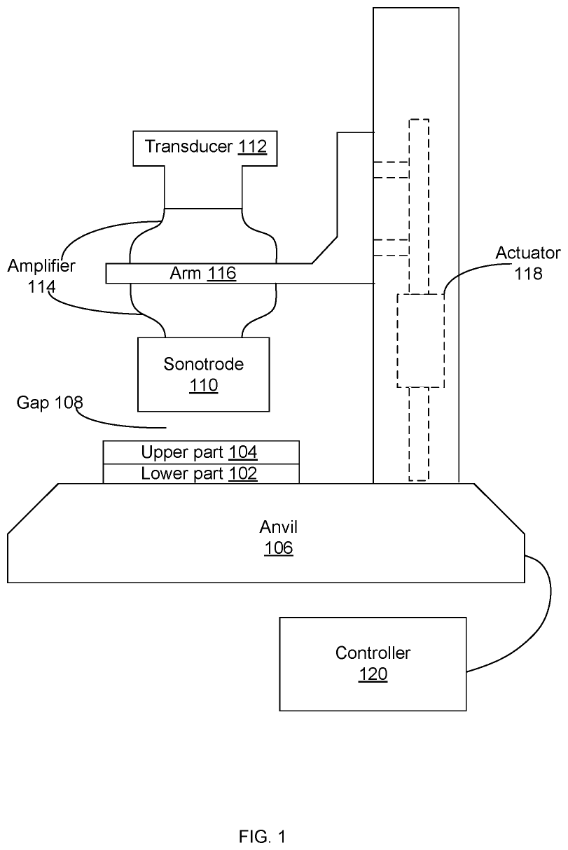

FIG. 1 is a schematic diagram of an ultrasonic welding assembly. A plurality of substrates to be joined through high-frequency bonding, such as, e.g., a paper material, may comprise a lower part 102 and an upper part 104. The paper material, such as, e.g., cardboard, paperboard, Couche paper, tissue paper, newsprint paper, repro paper, recycled paper, construction paper, or cardstock, may be thermoplastically coated, such as, e.g., with polyethylene or polypropylene. The paper material may be corrugated or non-corrugated. In some cases, lower part 102 and upper part 104 are made from the same paper material; while in other cases, they are made from different paper materials. Lower part 102 may be held in place by an anvil 106. Upper part 104 may be disposed above lower part 102. A joining force may be applied to gap 108, formed between sonotrode 110 and the anvil 106, wherein lower part 102 and upper part 104 are inserted.

Transducer 112 may be positioned near the top of the assembly and may convert electrical energy from a generator to mechanical vibrations used in the welding process. Transducer 112 may include, e.g., a number of piezo-electric ceramic discs sandwiched between two metal blocks. Between each of these ceramic disks, a thin metal plate may be positioned to form an electrode. A sinusoidal electrical signal may be fed to the transducer via the electrodes, causing the ceramic discs to expand and contract. This motion may produce an axial peak-to-peak amplitude of up to, e.g., approximately 100 μm, and a frequency of up to, e.g., approximately 100 kHz. Amplifier 114 may be disposed below transducer 108. Amplifier 114 may magnify the mechanical vibrations produced at the tip of the transducer and transfers the vibrations to sonotrode 110, which in turn transfers the energy to upper part 104. In some cases, sonotrode 110 amplitude may be set between 10 and 50 μm, and frequency may be set between 10 and 80 kHz; however, actual settings depend on the paper material that is used. In addition, amplifier 114 may provide an attachment point for arm 116. Sonotrode 110 may be positioned between amplifier 114 and upper part 104, and is formed from any suitably robust material, such as, e.g., aluminum or titanium. Sonotrode 110 may comprise a wedge-like shape that has a tapered bottom portion for magnifying energy into a contact point with a work piece, such as the pieces of paper; however, other designs may be used. Actuator 118 may exert a downward pressure on upper part 104 and lower part 102 through arm 116. Actuator 118 may be any technically feasible means of generating pressure, such as, e.g., pneumatic, mechanical, piezoelectric or hydraulic. For example, a piezoelectric actuator may be configured to apply a dynamically variable load to the welding assembly in response to an electrical signal provided by a pressure controller (not shown). Controller 120 may be electrically connected to the assembly and can be used to control the frequency and amplitude of vibrations produced by transducer 112, and the amount of force exerted by actuator 118. Power of the electrical signal provided to transducer 112 may be controlled by controller 120, which may be directly proportional to the power injected into the assembly to maintain a constant generated frequency.

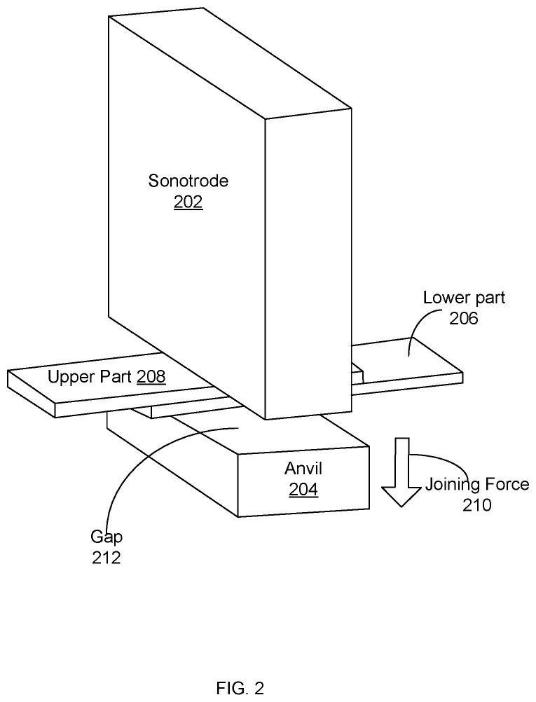

FIG. 2 is a schematic diagram of a portion of an ultrasonic welding assembly. The assembly comprises a sonotrode 202 and an anvil 204. A plurality of substrates to be joined through high-frequency bonding, such as, e.g., a paper material, may comprise a lower part 206 and an upper part 208. The paper material, such as, e.g., cardboard, paperboard, Couche paper, tissue paper, newsprint paper, repro paper, recycled paper, construction paper, or cardstock, may be thermoplastically coated, such as, e.g., with polyethylene or polypropylene. The paper material may be corrugated or non-corrugated. In some cases, lower part 206 and upper part 208 are made from the same paper material; while in other cases, they are made from different paper materials. Lower part 206 may be held in place by an anvil 204. Upper part 208 may be disposed above lower part 206. A joining force 210 may be applied to gap 212, formed between sonotrode 202 and the anvil 204, wherein lower part 206 and upper part 208 are inserted.

Sonotrode 202 may execute an ultrasonic oscillation in a particular direction, such as, e.g., parallel or perpendicular, to the joining force. Parallel may be defined as 180°, and perpendicular may be defined as 90°. Deviations of ±10° may still be viewed as perpendicular. This oscillation direction may correspond to the expansion direction of the amplitudes of the ultrasonic oscillation. Lower part 206 and upper part 208 may be joined to each other by friction through the application of the joining force 210 and ultrasonic oscillation. Anvil 204 may restrain the applied pressure load from bending, or otherwise deforming the lower part 206 and upper part 208. Melting of the coating then forms a physical connection between the pieces of paper, effectively fusing them together. In some cases, the paper material is not thermoplastically coated, and the heat energy that is generated from molecular friction permits direct joining of the pieces of paper. In other cases, ultrasonic welding of pieces of paper takes place with the inner joining points being moistened, e.g., with liquid water, water vapor, and/or a humectant. A moistening device for moistening the paper material may be provided (not shown). This facilitates a firm and stable joining of the paper material without adhesives, thermoplastic coatings, and printing ink or dyes. Demineralized water may be used, opposed to conventional water, which may have reduced surface tension of the moistening agent. This may lead to a more uniformly wetted area, and the ability to penetrate paper more quickly with a relatively high tensile strength. The moistening of joining points may be carried out before and/or during the ultrasonic welding process.

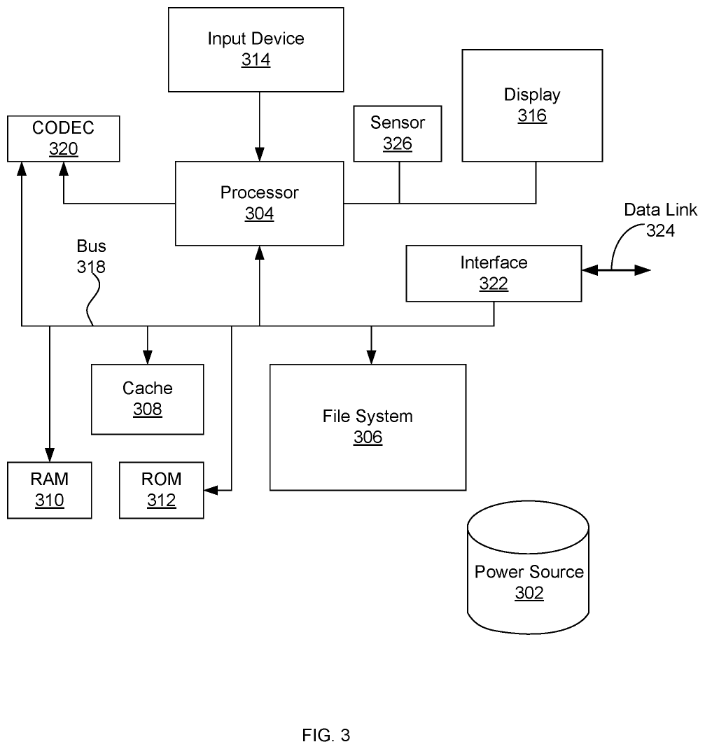

FIG. 3 is a block diagram of an electronic controller of an ultrasonic welding assembly. The controller may include power source 302, and processor 304 for controlling an overall operation of the assembly, and may comprise instruction data of manufacturing instructions in a file system 306 and a cache 308. File system 306 may be a storage disk or a plurality of disks, and typically provides high capacity storage capability for the controller. Since access time to file system 306 may be relatively slow, the controller may also include cache 308. Cache 308 is, for example, Random-Access Memory (RAM) provided by semiconductor memory, which may provide substantially shorter access time compared with file system 306. The controller may also include RAM 310 and Read-Only Memory (ROM) 312. ROM 312 may store programs, utilities or processes to be executed in a non-volatile manner. RAM 310 may provide volatile data storage, such as for cache 308.

A user input device 314 may allow a user to interact with the controller, and hence, the assembly. For example, user input device 314 may take a variety of forms, such as, e.g., a button, keypad, dial, touch screen, audio input interface, visual/image capture input interface, and/or input in the form of sensor data. Display 316 may be controlled by processor 304 to display information to the user. Bus 318 may facilitate data transfer between file system 306, cache 308, processor 304, and CODEC 320. CODEC 320 may be used to decode and play a plurality of media items from file system 303 that may correspond to certain activities taking place during a particular manufacturing process. Interface 322 may be communicatively coupled to data link 324, such as, e.g., a wired or wireless connection, and may permit the assembly to communicatively couple with a host computer or accessory device. Sensor 326 may be any form of circuitry for detecting any number of stimuli, such as, e.g., a magnetic field sensor, an audio sensor, and/or a light sensor, for monitoring a manufacturing operation.

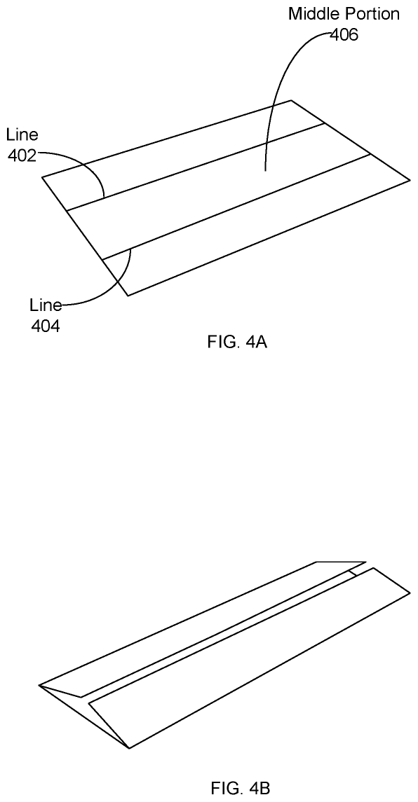

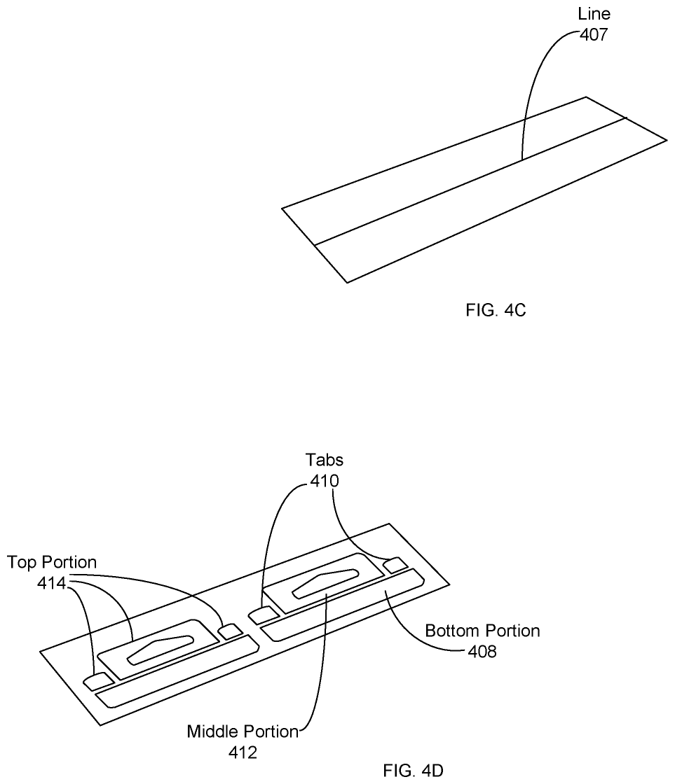

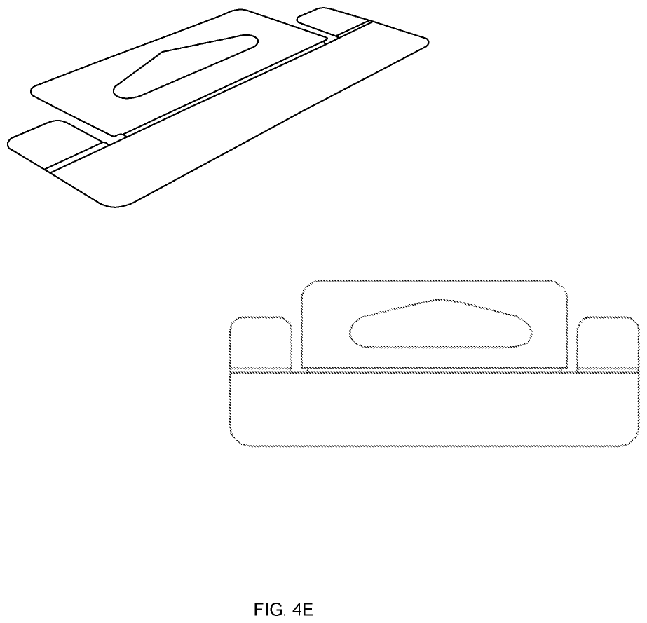

FIGS. 4A-E schematically outline a method for manufacturing a hang tab using an ultrasonic welding apparatus. In FIG. 4A, a paper blank may be coated on both sides with a thermoplastic material, such as, e.g., polyethylene or polypropylene. Kiss cuts using a cutting apparatus are made along line 402 and line 404 into the substantially rectangular shape paper blank to form two parallel fold lines along the paper blank's length, such as, e.g., at approximately equal distances from their respective edges, and may depend on a predetermined final shape and size of the hang tab. For example, each of the equal distances may be half of a middle portion 406 to which they are juxtaposed. The blank may comprise a paper weight in the range of 200 to 400 grams, and may be cut into a square or rectangular shape at a predetermined size, e.g., using a cutting apparatus or pair of scissors. FIG. 4B folds the paper blank along both line 402 and line 404, for example, which may reduce the blank's width into half. FIG. 4C bonds the two folds to the middle portion 406 of FIG. 4A using an ultrasonic welding apparatus, forming line 407. For example, the two distances from the edges of the paper blank's width to the line 407 may be equal, and may depend on a predetermined final shape and size of the hang tab. The apparatus may be set at 25 kW, with a preloading time of 2.0 seconds, and a welding position of 3.0 seconds, and a cooling time of 2.0 seconds, and bonding at 1.8 A. FIG. 4D die cuts one or more shapes of hang tabs from the paper blank. A hang tab may comprise a bottom portion 408 that may be generally square or rectangular shaped and may be configured to adhere to a packaging of an item for display, such as, e.g., with an adhesive, and a top portion 414 may comprise two generally square or rectangular shaped tabs 410 positioned on both sides of a larger generally square or rectangular shaped middle portion 412. Middle portion 412 of the top portion 414 may include a generally triangular portion, such as, e.g., an obtuse triangle shape, that is used to hang the hang tab, for example, onto a hook of a retail environment. The triangular portion may comprise rounded corners at the two acute angles and a sharp corner at the obtuse angle. Top portion 414 and bottom portion 408 may be divided by middle line 407. Middle line 407 may include a groove or depression formed from the folds of FIG. 4B, and may be flexible or bendable. FIG. 4E is a schematic diagram of a finished product of the hang tab manufactured using an ultrasonic welding apparatus. The hang tab may comprise rounded or sharp peripheral corners at tabs 410 and/or middle portion 412 of top portion 414, and bottom portion 408.

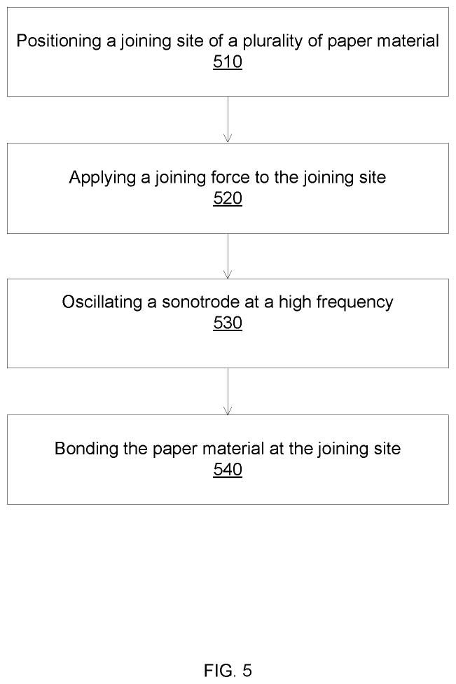

FIG. 5 is a flowchart of a method for joining a plurality of paper material using an ultrasonic welding apparatus. Operation 510 positions a joining site of a plurality of paper material within a gap between a sonotrode and an anvil of the ultrasonic welding apparatus. Operation 520 applies a joining force to the joining site in a predetermined direction to secure the plurality of paper material. The joining force may be applied by an actuator, such as, e.g., pneumatic, mechanical, piezoelectric or hydraulic. Operation 530 oscillates the sonotrode at a high frequency. The oscillation may be either parallel or perpendicular to the joining force. A transducer of the apparatus may be configured to impart the oscillation to a welding tip of the sonotrode in response to an electrical signal received from an electronic controller. Operation 540 bonds the paper material at the joining site. Adequate compaction of the pieces of paper is produced in addition to a high development of heat from friction generated in a micro-region. Melting of thermoplastic coating then forms a physical connection between the pieces of paper, effectively fusing them together.

In some cases, the paper material is not thermoplastically coated, and the heat energy that is generated from molecular friction permits direct joining of the pieces of paper. In other cases, ultrasonic welding of pieces of paper takes place with the inner joining points being moistened, e.g., with liquid water, water vapor, and/or a humectant. This facilitates a firm and stable joining of the paper material without adhesives, thermoplastic coatings, and printing ink or dyes. Demineralized water may be used, opposed to conventional water, which may have reduced surface tension of the moistening agent. This may lead to a more uniformly wetted area, and the ability to penetrate paper more quickly with a relatively high tensile strength.

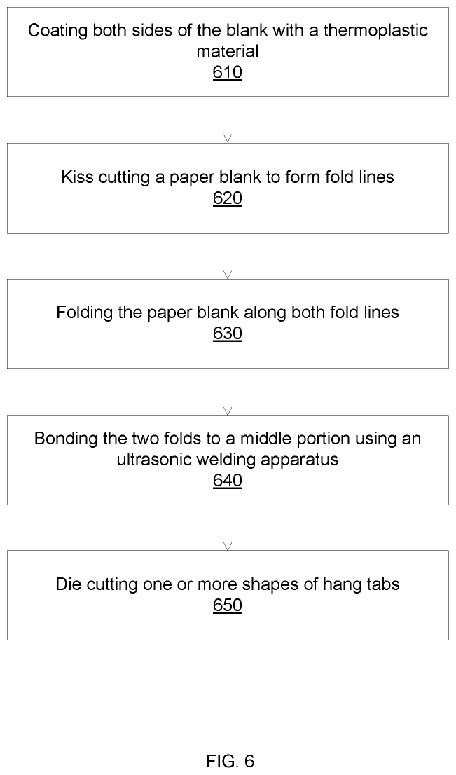

FIG. 6 is a flowchart of a method for manufacturing a hang tab using an ultrasonic welding apparatus. Operation 610 coats both sides of a paper blank with a thermoplastic material, such as, e.g., polyethylene or polypropylene. The blank may comprise a paper weight in the range of 200 to 400 grams, and may be cut into a square or rectangular shape at a predetermined size, e.g., using the cutting apparatus or pair of scissors. Operation 620 kiss cuts the paper blank to form two parallel fold lines, for example, at approximately equal distances from their respective edges, depending on a predetermined final shape and size of the hang tab. For example, each of the equal distances may be half of a middle portion to which they are juxtaposed. Operation 630 folds the paper blank along both fold lines, which may reduce the blank's width into half. Folding of the paper blank may be performed directly by human hands, or an electronically powered tool (not shown). Operation 640 bonds the two folds to the middle portion using an ultrasonic welding apparatus, forming a middle line. For example, the two distances from the edges of the paper blank's width to the middle line may be equal, and may depend on a predetermined final shape and size of the hang tab. The apparatus may be set at 25 kW, with a preloading time of 2.0 seconds, and a welding position of 3.0 seconds, and a cooling time of 2.0 seconds, and bonding at 1.8 A. Operation 650 die cuts one or more shapes of hang tabs from the paper blank. A bottom portion may be generally square or rectangular shaped, and a top portion may comprise two generally square or rectangular shaped tabs positioned on both sides of a larger generally square or rectangular shaped middle portion. The middle portion of the top portion may include a generally triangular portion, such as, e.g., an obtuse triangle shape, that is used to hang the hang tab, for example, onto a hook of a retail environment. The top portion and the bottom portion may be divided by a middle line. The middle line may include a groove or depression formed from the folds.

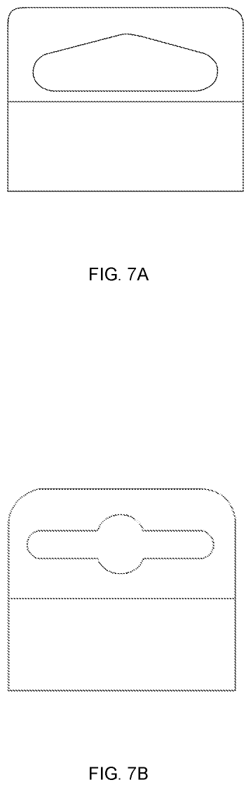

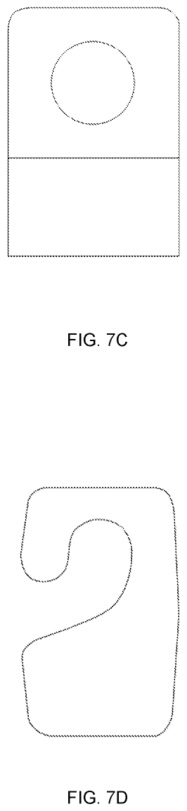

FIGS. 7A-D illustrate a variety of hang tab shapes that may be manufactured using an ultrasonic welding apparatus. In each of the shapes, a bottom portion, which is approximately half the length of the hang tab (for example), is generally square or rectangular, similar to the hang tab presented in FIG. 7E, and may be configured to adhere to a packaging of an item for display, such as, e.g., with an adhesive. Each of the hang tabs may comprise rounded or sharp outer corners at a top portion and the bottom portion. In FIG. 7A, the top portion may be generally square or rectangular comprising a generally triangular opening, such as, e.g., an obtuse triangle shape, that is used to hang the hang tab, for example, onto a hook of a retail environment. The triangular portion may comprise rounded corners at the two acute angles and a sharp corner at the obtuse angle. FIG. 7B shows the top portion comprising an oblong shape that includes two rounded ends, and a middle portion with a half circle positioned above and another half circle positioned below. The oblong-shaped portion may be used to hang the hang tab, for example, onto a hook of a retail environment. FIG. 7C shows the top portion comprising a generally square or rectangular shape with a circular opening positioned within its center that is used to hang the hang tab, for example, onto a hook of a retail environment. FIG. 7D shows the top portion comprising a generally hook-shape that is used to hang the hang tab, for example, onto a hook of a retail environment.

A number of examples have been described. Nevertheless, it will be understood that various modifications may be made without departing from the spirit and scope of the claimed invention. In addition, the logic flows depicted in the figures do not require the particular order shown, or sequential order, to achieve desirable results. Other steps may be provided, or steps may be eliminated, from the described flows, and other components may be added or removed. Accordingly, other examples are within the scope of the following claims.

What is claimed is:

1. A method, comprising:
coating the paper blank with a thermoplastic material;
cutting a paper blank to form one or more fold lines;
folding the paper blank along the one or more fold lines;
bonding one or more folds corresponding to the fold lines to a middle portion of the paper blank using an ultrasonic welding apparatus; and
die cutting one or more shapes of a hang tab.

2. A method of claim 1, further comprising:
wherein bonding the one or more folds comprises positioning a joining site of the one or more folds and the middle portion within a gap between a sonotrode and an anvil of the ultrasonic welding apparatus.

3. A method of claim 2, further comprising:
applying a joining force to the joining site.

4. A method of claim 3, further comprising:
oscillating the sonotrode at an ultrasonic frequency.

5. A method of claim 4, further comprising:
wherein oscillation of the sonotrode is parallel to the joining force.

6. A method of claim 1, further comprising:
wherein a fold is half the width of the middle portion of the paper blank.

7. A method of claim 1, further comprising:
wherein a bottom portion of the hang tab is substantially square shape.

8. A method of claim 1, further comprising:
wherein a top portion of the hang tab comprises a substantially square shape middle portion disposed between two substantially square shape tabs.

9. A method of claim 8, further comprising:
wherein the middle portion is larger than the two substantially square shape tabs.

10. A method of claim 9, further comprising:
wherein the middle portion comprises a substantially triangular opening.

11. A method of claim 10, further comprising:
wherein the substantially triangular opening is configured to mount to a display apparatus of a retail environment.

12. A method of claim 10, further comprising:
wherein the substantially triangular opening comprises two rounded acute corners and a sharp obtuse corner.

13. A method, comprising:
kiss-cutting a paper blank to form two parallel fold lines along the paper blank's length;
folding the paper blank inward along the fold lines toward a middle line of the paper blank;
positioning a joining site of the folds and a middle portion of the paper blank within a gap between a sonotrode and an anvil of the ultrasonic welding apparatus;
applying a joining force to the joining site for holding the folds and the middle portion stationary;
vibrating the sonotrode at an ultrasonic frequency to bond the folds to the middle portion; and
die cutting one or more shapes of a hang tab.

14. A method of claim 13, further comprising:
wherein the middle line is formed by outer perimeters of the two folds, and
wherein the folds overlap the middle portion.

15. A method of claim 13, further comprising:
wherein a bottom portion of the hang tab is configured to adhere to a packaging of a retail product.

16. A method of claim 13, further comprising:
wherein vibration of the sonotrode is perpendicular to the joining force.

17. A method of claim 13, further comprising:
wherein a top portion of the hang tab comprises an opening configured to mount to a display apparatus of a retail environment.

18. A method, comprising:
cutting a paper blank to form two parallel fold lines along the paper blank's length,
wherein the paper blank's weight is in the range of 200 to 400 grams,
wherein the paper blank is non-corrugated;
folding the paper blank inward along the fold lines toward a middle line of the paper blank;
positioning a joining site of the folds and a middle portion of the paper blank within a gap between a sonotrode and an anvil of the ultrasonic welding apparatus;
applying a joining force to the joining site for holding the folds and the middle portion stationary;
vibrating the sonotrode at an ultrasonic frequency to bond the folds to the middle portion; and
die cutting one or more shapes of a hang tab.

19. A method of claim 18, further comprising:
wherein a top portion and a bottom portion of the hang tab are divided by the middle line.

20. A method of claim 18, further comprising:
wherein the middle line is a physical depression formed from the folds.
